(19) United States
(12) Patent Application Publication
(10) Pub. No.: US 2011/0249140 A1
(43) Pub. Date: Oct. 13, 2011

(54) ELECTRONIC CAMERA

(75) Inventors: Takeshi FUJIWARA, Osaka (JP); Seiji Yamamoto, Daito-shi (JP); Seigo Hayashi, Kizugawa-shi (JP)

(73) Assignee: Sanyo Electric Co., Ltd., Osaka (JP)

(21) Appl. No.: 13/083,805

(22) Filed: Apr. 11, 2011

(30) Foreign Application Priority Data
Apr. 12, 2010 (JP) 2010-091315

(51) Int. Cl. H04N 9/73; H04N 9/68

(52) U.S. Cl. 348/223.1; 348/234; 348/E09.051; 348/E09.053

(57) ABSTRACT

An electronic camera includes an imager. An imager repeatedly outputs an image representing a scene captured by an imaging surface. An adjuster adjusts an imaging condition by referring to any one of a plurality of adjustment references including a specific adjustment reference suitable for outdoors. A controller controls whether or not the referring by the adjuster to the specific adjustment reference should be permitted, with reference to a determined result of whether or not an average luminance of the image outputted from the imager satisfies a first condition and a determined result of whether or not a ratio of an area having a luminance deviating from a predetermined range occupying in the image outputted from the imager satisfies a second condition.

### CROSS REFERENCE OF RELATED APPLICATION

The disclosure of Japanese Patent Application No. 2010-91315, which was filed on Apr. 12, 2010, is incorporated here by reference.

### BACKGROUND OF THE INVENTION

1. Field of the Invention

The present invention relates to an electronic camera. More particularly, the present invention relates to an electronic camera which adjusts an imaging condition with reference to a scene image outputted from an imaging device.

2. Description of the Related Art

According to one example of this type of camera, a hue data generating section generates hue data corresponding to each of a plurality of blocks allocated to an imaging surface. A block counting section counts, corresponding to each of a plurality of reference hue data ranges respectively corresponding to a plurality of photographing scenes, the number of blocks having hue data belonging to the reference hue data range. A hue contrast arithmetic section evaluates a contrast of the hue based on the hue data of each block. A photographing scene determining section determines a photographing scene based on a counted result of the block counting section and the contrast evaluated by the hue contrast arithmetic section. A white-balance gain arithmetic section adjusts a white-balance gain based on a determined result of the photographing scene determining section. Thereby, a white-balance adjustment suitable for each of a photographing scene of the outdoors and a photographing scene of the indoors is realized.

However, in the above-described camera, a luminance distribution of a scene image is not referred to upon determining the photographing scene, and thus, an imaging performance is limited.

### SUMMARY OF THE INVENTION

An electronic camera according to the present invention, comprises: an imager which repeatedly outputs an image representing a scene captured by an imaging surface; an adjuster which adjusts an imaging condition by referring to any one of a plurality of adjustment references including a specific adjustment reference suitable for outdoors; and a controller which controls whether or not the referring by the adjuster to the specific adjustment reference should be permitted, with reference to a determined result of whether or not an average luminance of the image outputted from the imager satisfies a first condition and a determined result of whether or not a ratio of an area having a luminance deviating from a predetermined range occupying in the image outputted from the imager satisfies a second condition.

According to the present invention, a computer program embodied in a tangible medium, which is executed by a processor of an electronic camera provided with an imager which repeatedly outputs an image representing a scene captured by an imaging surface, comprises: an adjusting instruction to adjust an imaging condition by referring to any one of a plurality of adjustment references including a specific adjustment reference suitable for outdoors; and a controlling instruction to control whether or not the referring by the adjusting instruction to the specific adjustment reference should be permitted, with reference to a determined result of whether or not an average luminance of the image outputted from the imager satisfies a first condition and a determined result of whether or not a ratio of an area having a luminance deviating from a predetermined range occupying in the image outputted from the imager satisfies a second condition.

According to the present invention, an imaging control method executed by an electronic camera provided with an imager which repeatedly outputs an image representing a scene captured by an imaging surface, the imaging control method comprises: an adjusting step of adjusting an imaging condition by referring to any one of a plurality of adjustment references including a specific adjustment reference suitable for outdoors; and a controlling step of controlling whether or not the referring by the adjusting step to the specific adjustment reference should be permitted, with reference to a determined result of whether or not an average luminance of the image outputted from the imager satisfies a first condition and a determined result of whether or not a ratio of an area having a luminance deviating from a predetermined range occupying in the image outputted from the imager satisfies a second condition.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a color filter applied to the embodiment in FIG. 2;

FIG. 4 is an illustrative view showing one example of an allocation state of a cut-out area in an imaging surface;

FIG. 5 is an illustrative view showing one example of an allocation state of an evaluation area in the imaging surface;

FIG. 6 is an illustrative view showing one example of an allocation state of a motion detection block in the imaging surface;

FIG. 7 (A) is an illustrative view showing one example of a character corresponding to a night-view scene;

FIG. 7 (B) is an illustrative view showing one example of a character corresponding to an action scene;

FIG. 7 (C) is an illustrative view showing one example of a character corresponding to a landscape scene;

FIG. 7 (D) is an illustrative view showing one example of a character corresponding to a default scene;

FIG. 8 is an illustrative view showing one example of a distribution of a color temperature;

FIG. 9 is an illustrative view showing one example of a scene captured by the imaging surface;

FIG. 10 is an illustrative view showing another example of a scene captured by the imaging surface;

FIG. 11 is a graph showing one example of a program chart corresponding to the night-view scene;

FIG. 12 is a graph showing one example of a program chart corresponding to the action scene;

FIG. 13 is a graph showing one example of a program chart corresponding to the landscape scene;

FIG. 14 is a graph showing one example of a program chart corresponding to the default scene;

FIG. 15 is a flowchart showing one portion of behavior of a CPU applied to the embodiment in FIG. 2;

FIG. 16 is a flowchart showing another portion of behavior of the CPU applied to the embodiment in FIG. 2;

FIG. 17 is a flowchart showing still another portion of behavior of the CPU applied to the embodiment in FIG. 2;

FIG. 18 is a flowchart showing yet another portion of behavior of the CPU applied to the embodiment in FIG. 2;

FIG. 19 is a flowchart showing another portion of behavior of the CPU applied to the embodiment in FIG. 2;

FIG. 20 is a flowchart showing still another portion of behavior of the CPU applied to the embodiment in FIG. 2;

FIG. 21 is a flowchart showing yet another portion of behavior of the CPU applied to the embodiment in FIG. 2;

FIG. 22 is a flowchart showing another portion of behavior of the CPU applied to the embodiment in FIG. 2;

FIG. 23 is a flowchart showing still another portion of behavior of the CPU applied to the embodiment in FIG. 2;

FIG. 24 is a flowchart showing yet another portion of behavior of the CPU applied to the embodiment in FIG. 2; and

FIG. 25 is a flowchart showing another portion of behavior of the CPU applied to the embodiment in FIG. 2.

### DETAILED DESCRIPTION OF THE PREFERRED EMBODIMENTS

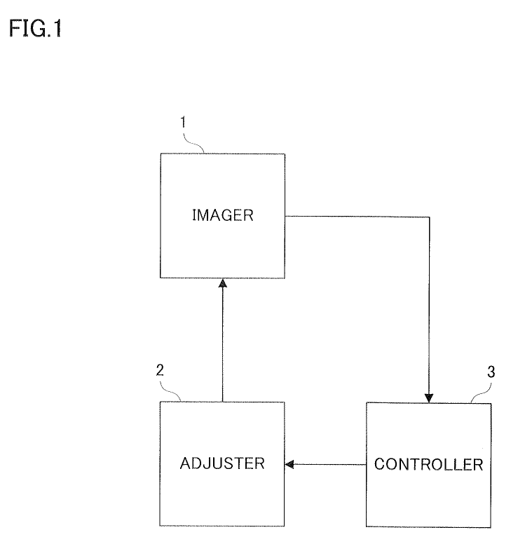

With reference to FIG. 1, an electronic camera of one embodiment of the present invention is basically configured as follows: An imager 1 repeatedly outputs a scene image representing a scene captured by an imaging surface. An adjuster 2 adjusts an imaging condition by referring to any one of a plurality of adjustment references including a specific adjustment reference suitable for outdoors. A controller 3 controls whether or not the referring by the adjuster 2 to the specific adjustment reference should be permitted, with reference to a determined result of whether or not an average luminance of the image outputted from the imager 1 satisfies a first condition and a determined result of whether or not a ratio of an area having a luminance deviating from a predetermined range occupying in the image outputted from the imager 1 satisfies a second condition.

Upon controlling whether or not the referring to the specific adjustment reference suitable for the outdoors should be permitted, not only an average luminance of the image but also a ratio of an area having a luminance deviating from a predetermined range occupying in the image are referred to. This avoids an erroneous determination of whether or not the scene captured by the imaging surface is outdoors, by extension, an erroneous selection of the adjustment reference, and improves an imaging performance.

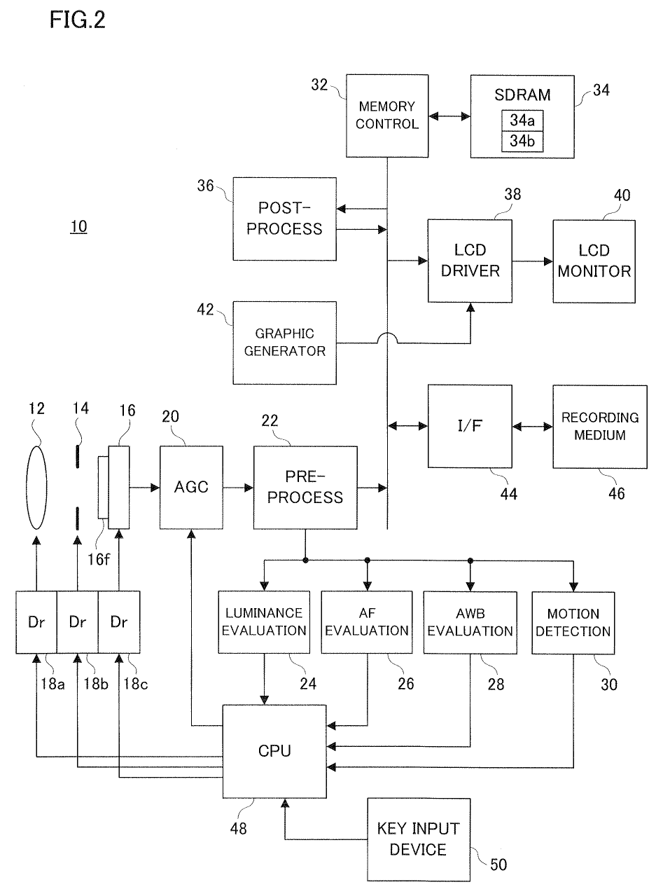

With reference to FIG. 2, a digital video camera 10 according to one embodiment includes a focus lens 12 and an aperture unit 14 respectively driven by drivers 18a and 18b. An optical image of a scene enters, with irradiation, an imaging surface of an imaging device 16 through these components.

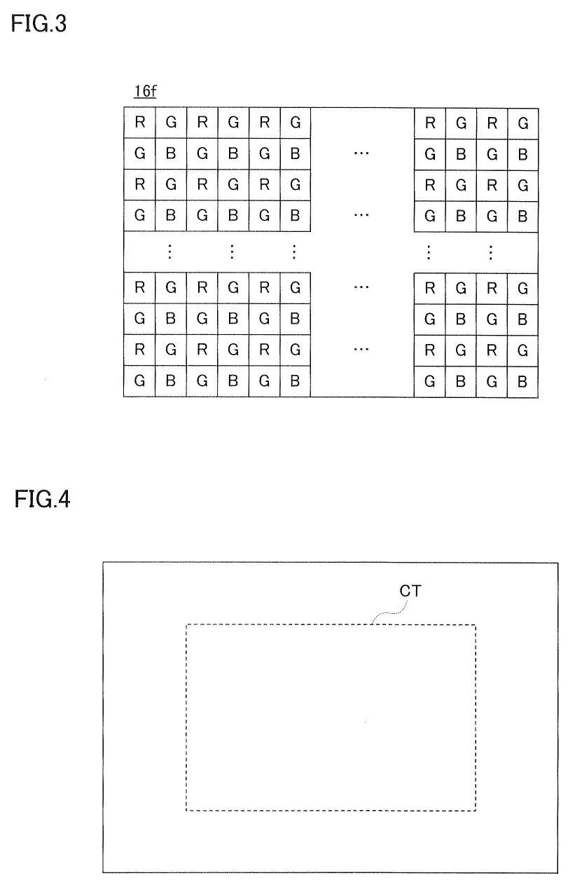

A plurality of light receiving elements (=pixels) are placed two-dimensionally on the imaging surface, and the imaging surface is covered with a primary color filter 16f having a Bayer array shown in FIG. 3. Specifically, the color filter 16f is equivalent to a filter in which a filter factor of R (Red), a filter factor of G (Green), and a filter factor of B (Blue) are arrayed in mosaic. The light receiving elements placed on the imaging surface correspond one by one to the filter factors configuring the color filter 16f, and an amount of electric charges produced by each light receiving element reflects an intensity of light corresponding to color of R, G, or B.

When a power source is applied, a CPU 48 starts up a driver 18c in order to execute a moving-image taking process under an imaging task. In response to a cyclically-generated vertical synchronization signal Vsync, the driver 18c exposes the imaging surface and reads out the electric charges produced on the imaging surface in a raster scanning manner. From the imaging device 16, raw image data representing the scene is cyclically outputted. The outputted raw image data is equivalent to image data in which each pixel has color information of any one of R, G, and B.

An AGC circuit 20 amplifies the raw image data outputted from the imaging device 16 by referring to an AGC gain set by the CPU 48. A pre-processing circuit 22 performs processes, such as digital clamp and a pixel defect correction, on the raw image data amplified by the AGC circuit 20. The raw image data on which such a pre-process is performed is written, through a memory control circuit 32, into a raw image area 34a of an SDRAM 34.

With reference to FIG. 4, a cut-out area CT is allocated to the raw image area 34a. A post-processing circuit 36 accesses the raw image area 34a through the memory control circuit 32 so as to cyclically read out the raw image data belonging to the cut-out area CT. The read-out raw image data is subjected to processes, such as a color separation, a white balance adjustment, an edge/chroma emphasis, and a YUV conversion, in the post-processing circuit 36.

Firstly, the raw image data is converted to RGB-formatted image data, in which each pixel has all the color information items of R, G, and B, by the color separating process. A white balance of the image data is adjusted by the white-balance adjusting process, an edge and/or a chroma of the image data is emphasized by the edge/chroma emphasizing process, and a format of the image data is converted to a YUV format by the YUV converting process. The YUV-formatted image data created in this way is written, through the memory control circuit 32, into a YUV image area 34b of the SDRAM 34.

An LCD driver 38 cyclically reads out the image data accommodated in the YUV image area 34b, reduces the read-out image data so as to be adapted to a resolution of an LCD monitor 40, and drives the LCD monitor 40 based on the reduced image data. As a result, a real-time moving image (live view image) representing the scene is displayed on a monitor screen.

With reference to FIG. 5, an evaluation area EVA is allocated to a center of the imaging surface. The evaluation area EVA is divided into 16 portions in each of a horizontal direction and a vertical direction, and this means that the evaluation area EVA is formed by a total of 256 divided areas.

In addition to the above-described process, the pre-processing circuit 22 performs a process of simply converting the raw image data into Y data, and applies the converted Y data to the luminance evaluating circuit 24, the AF evaluating circuit 26, and the motion detecting circuit 30. Moreover, the pre-processing circuit 22 performs a process of simply converting the raw image data into RUB image data (RGB image data having a white balance adjusted according to an initial gain), and applies the converted RGB image data to an AWB evaluating circuit 28.

In response to the vertical synchronization signal Vsync, the luminance evaluating circuit 24 integrates Y data belonging to the evaluation area EVA, out of the applied Y data, for each divided area. From the luminance evaluating circuit 24, the 256 luminance evaluation values are outputted in synchronization with the vertical synchronization signal Vsync. The CPU 48 takes the luminance evaluation values thus outputted under a brightness adjusting task, calculates an appropriate BV value (BV: Brightness Value) based on the taken luminance evaluation values, and sets an aperture amount, an exposure time, and an AGC gain that define the calculated appropriate BV value, to the drivers 18b and 18c and the AGC circuit 20. As a result, the brightness of the live view image is adjusted moderately.

In response to the vertical synchronization signal Vsync, the AF evaluating circuit 26 integrates a high frequency component of Y data belonging to the evaluation area EVA, out of the applied Y data, for each divided area. From the AF evaluating circuit 26, 256 AF evaluation values are outputted in synchronization with the vertical synchronization signal Vsync. The CPU 48 takes the AF evaluation values thus outputted under a continuous AF task, and executes an AF process when an AF start-up condition is satisfied. The focus lens 12 is placed at a focal point by the driver 18a, and as a result, a sharpness of the live view image is continuously improved.

In response to the vertical synchronization signal Vsync, the AWB evaluating circuit 28 integrates each of R data, G data, and B data that form the applied RGB image data, for each divided area. From the AWB evaluating circuit 28, 256 AWB evaluation values, each of which has an R integral value, a G integral value, and a B integral value, are outputted in synchronization with the vertical synchronization signal Vsync. The CPU 48 takes the AWB evaluation values thus outputted under an AWB task, and executes an AWB process based on the taken AWB evaluation values. The white-balance adjustment gain referred to in the post-processing circuit 36 is adjusted to an appropriate value by the AWB process, and a tonality of the live view image is thereby adjusted moderately.

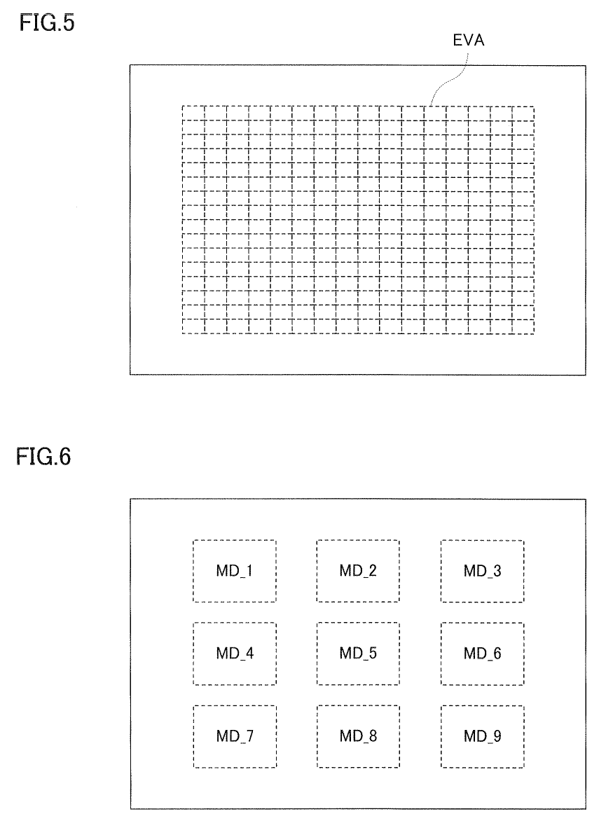

With reference to FIG. 6, nine motion detection blocks MD_1 to MD_9 are allocated to the imaging surface. The motion detection blocks MD_1 to MD_3 are placed to be aligned in a horizontal direction at an upper level of the imaging surface, the motion detection blocks MD _4 to MD_6 are placed to be aligned in a horizontal direction at a medium level of the imaging surface, and the motion detection blocks MD_7 to MD_9 are placed to be aligned in a horizontal direction at a lower level of the imaging surface.

The motion detecting circuit 30 detects nine partial motion vectors respectively corresponding to the motion detection blocks MD_1 to MD_9, based on the Y data. The detected partial motion vectors are outputted from the motion detecting circuit 30 in synchronization with the vertical synchronization signal Vsync. The CPU 48 takes the outputted partial motion vectors under an image-stabilizing task, and based thereon, executes an image-stabilizing process. When a movement of the imaging surface in a direction orthogonal to an optical axis is equivalent to a camera shake of the imaging surface, the cut-out area CT moves in a direction to compensate this camera shake. This inhibits a live-view-image vibration resulting from the camera shake.

When a recording start operation is performed on a key input device 50, the CPU 48 applies a recording start command to an I/F 44 under an imaging task in order to start a moving image recording. The I/F 44 reads out the image data accommodated in the YUV image area 34b through the memory control circuit 32, and writes the read-out image data into a moving-image file created in a recording medium 46. When a recording end operation is performed on the key input device 50, the CPU 48 applies a recording end command to the I/F 44 under the imaging task in order to end the moving image recording. The FF 44 ends reading out the image data, and closes the moving-image file of a recording destination.

The CPU 48 cyclically determines to which one of the night-view scene, the action scene, and the landscape scene the captured scene is equivalent, under a scene determining task executed in parallel with the imaging task. The night-view scene determination and the landscape scene determination are executed based on the luminance evaluation values outputted from the luminance evaluating circuit 24. When the captured scene is determined to be the night-view scene, a flag FLGnight is updated from “0” to “1”, and when the captured scene is determined to be the landscape scene, a flag FLGlndscp is updated from “0” to “1”. Moreover, the action scene determination is executed based on the partial motion vectors outputted from the motion detecting circuit 30 and the luminance evaluation values outputted from the luminance evaluating circuit 24. When the captured scene is determined to be the action scene, the flag FLGact is updated from “0” to “1”.

When the flag FLGnight is “1”, the night-view scene is regarded as a finalized scene irrespective of statuses of the flag FLGlndscp and FLGact. Moreover, when the flag FLGnight is “0” and the flag FLGact is “1”, the action scene is regarded as the finalized scene irrespective of a status of the flag FLGlndscp. Further, when the flag FLGnight and the FLGact are “0” and the flag FLGlndscp is “1”, the landscape scene is regarded as the finalized scene. Moreover, when all of the flags FLGnight, FLGact, and FLGlndscp are “0”, the default scene is regarded as the finalized scene.

The CPU 48 requests a graphic generator 42 to output a character corresponding to the finalized scene thus obtained. The graphic generator 42 applies graphic data that responds to the request, to the LCD driver 38, and the LCD driver 38 drives the LCD monitor 40 based on the applied graphic data.

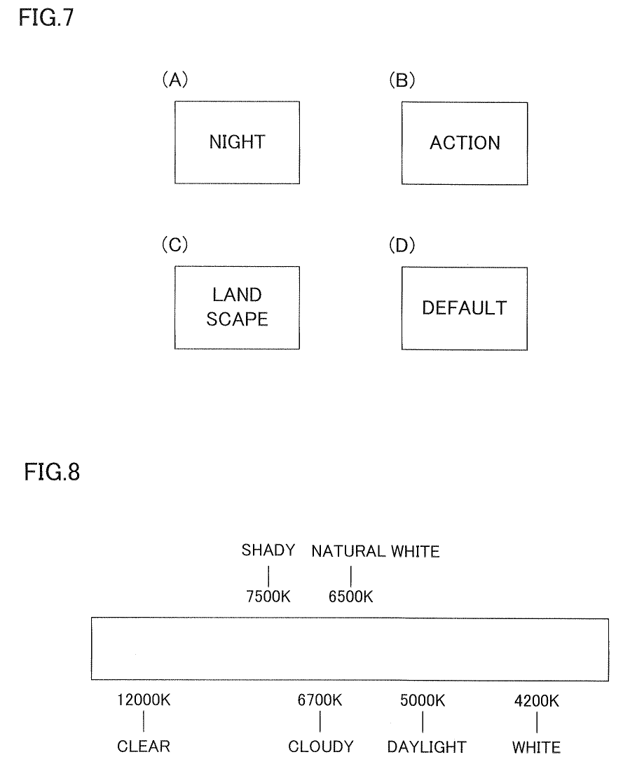

As a result, if the finalized scene is the night-view scene, then a character shown in FIG. 7(A) is displayed at an upper right of the monitor screen, and if the finalized scene is the action scene, a character shown in FIG. 7(B) is displayed at the upper right of the monitor screen. Moreover, if the finalized scene is the landscape scene, then a character shown in FIG. 7(C) is displayed at the upper right of the monitor screen, and if the finalized scene is the default scene, a character shown in FIG. 7(D) is displayed at the upper right of the monitor screen.

A landscape scene determining process is executed according to the following procedure. Firstly, a subject distance SD is measured with reference to a current position of the focus lens 12. When the measured subject distance SD is equal to or less than a threshold value THsd, it is regarded that a subject exists near the imaging surface. At this time, the value of the flag FLGlndscp is finalized to “0”.

When the measured subject distance SD exceeds the threshold value THsd, an average value of the 256 luminance evaluation values taken under the brightness adjusting task is calculated as “Yave”. When the calculated average value Yave is equal to or less than a threshold value THyave, it is regarded that a brightness of the scene is smaller than a brightness equivalent to the landscape. At this time, the value of the flag FLGlndscp is finalized to “0”.

When the average value Yave exceeds the threshold value THyave, a color temperature of the scene image is measured corresponding to each of the 256 divided areas. Upon measurement, the 256 AWB evaluation values taken under the AWB task is referred to. When the measured color temperature is equivalent to an indoor light (Natural White, Daylight or White), a variable CNT_IN is incremented while when the measured color temperature is equivalent to an outdoor light (Clear, Cloudy or Shady), a variable CNT_OUT is incremented. Upon completion of measuring the color temperatures in all of the divided areas, the variable CNT_IN indicates a ratio of a scene image affected by the indoor light, and the variable CNT_OUT indicates a ratio of a scene image affected by the outdoor light.

It is noted that the color temperature is distributed as shown in FIG. 8. According to FIG. 8, the Natural White has a color temperature of 6500K, the Daylight has a color temperature of 5000K, and the White has a color temperature of 4200K. Moreover, the Clear has a color temperature of 12000K, the Shady has a color temperature of 7500K, and the Cloudy has a color temperature of 6700K.

Furthermore, when the average value Yave exceeds the threshold value THyave, each of the 256 luminance evaluation values taken under the brightness adjusting task is compared to reference values REFyhigh and REFylow. When the luminance evaluation value exceeds the reference value REFyhigh, a variable CNT_H is incremented while when the luminance evaluation value exceeds the reference value REFylow, a variable CNT_L is incremented.

Here, the reference value REFyhigh is larger than the reference value REFylow. More specifically, the reference value REFyhigh is equivalent to a very large luminance, and the reference value REFylow is equivalent to a very small luminance. Upon completion of comparing the luminance evaluation values in all of the divided areas, the variable CNT_H indicates a ratio of an area having the very large luminance, and the variable CNT_L indicates a ratio of an area having the very small luminance.

When the variable CNT_IN is equal to or more than a threshold value THin, or when the variable CNT_OUT is equal to or less than a threshold value THout, the scene is regarded as being different from the landscape because it is strongly affected by the indoor light or it is lightly affected by the outdoor light. Moreover, when the variable CNT_H is equal to or more than a threshold value THyhigh and the variable CNT_L is equal to or more than a threshold value THylow, the scene is regarded as being different from the landscape because the ratio of the area having the very large luminance and the ratio of the area having the very small luminance are large. In this case, the value of the flag FLGlndscp is finalized to “0”.

On the other hand, when the variable CNT_IN falls below the threshold value THin and the variable CNT_OUT exceeds the threshold value THout, furthermore, when the variable CNT_H falls below the threshold value THyhigh, or when the variable CNT_L falls below the threshold value THylow, the scene is regarded as being equivalent to the landscape. At this time, the value of the flag FLGlndscp is finalized to “1”.

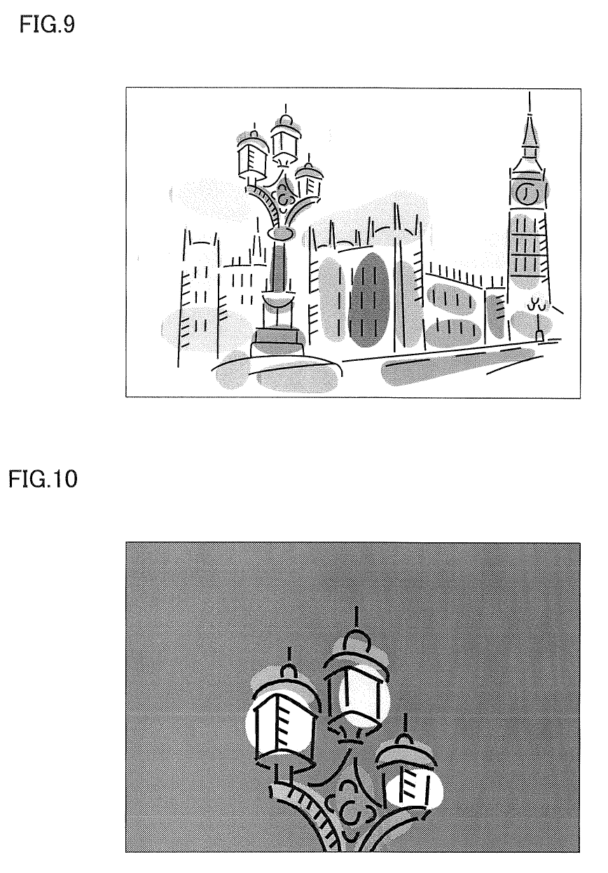

A setting of the flag FLGlndscp is thus controlled, and as a result, the FLGlndscp is set to “1” when a landscape shown in FIG. 9 is captured by the imaging surface. However, when a street lamp which is a part of the landscape shown in FIG. 9 is captured close up, a brightness around the street lamp is decreased by an exposure adjustment (see FIG. 10). At this time, the subject distance SD falls below the threshold value THsd, or the variables CNT_L and CNT_H are respectively equal to or more than the threshold values THylow and THyhigh, and thereby, the value of the flag FLGlndscp is set to “0”.

More particularly, the process under the brightness adjusting task is executed according to the following procedure: Firstly, the aperture amount, the exposure time, and the AGC gain are initialized, and a program chart adapted to the default scene (=initial finalized scene) is designated as a referring program chart. When the vertical synchronization signal Vsync is generated, the appropriate BV value is calculated based on the luminance evaluation values outputted from the luminance evaluating circuit 24, and coordinates (A, T, G) corresponding to the calculated appropriate BV value are detected from the referring program chart. It is noted that “A” corresponds to the aperture amount, “T” corresponds to the exposure time, and “G” corresponds to the AGC gain.

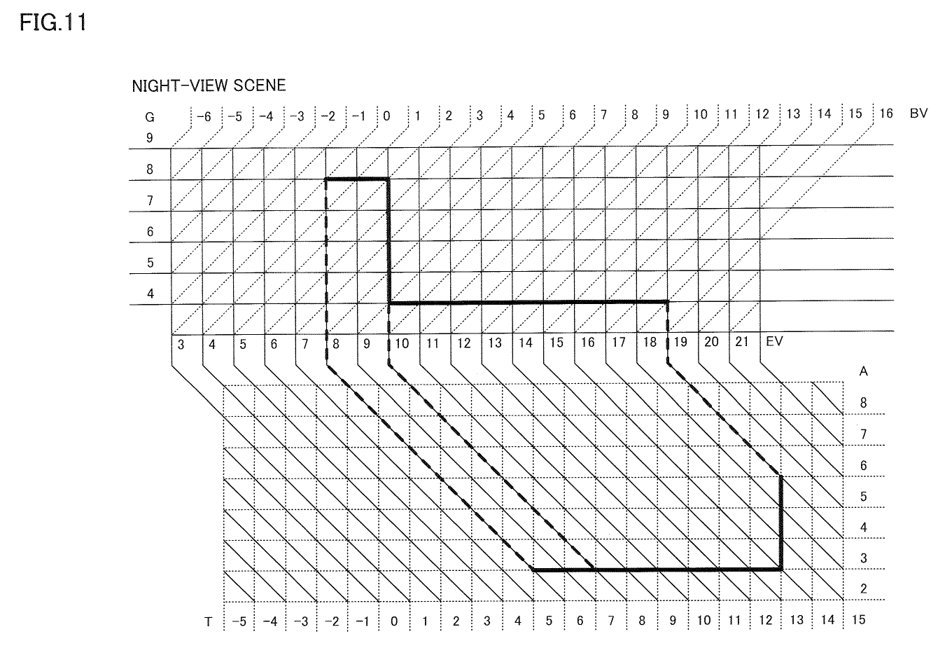

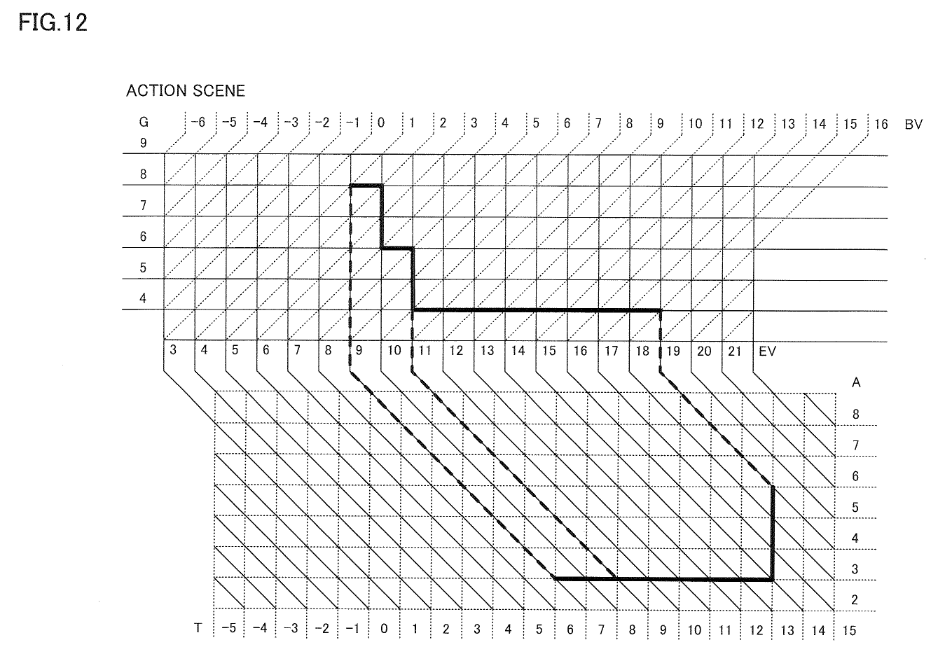

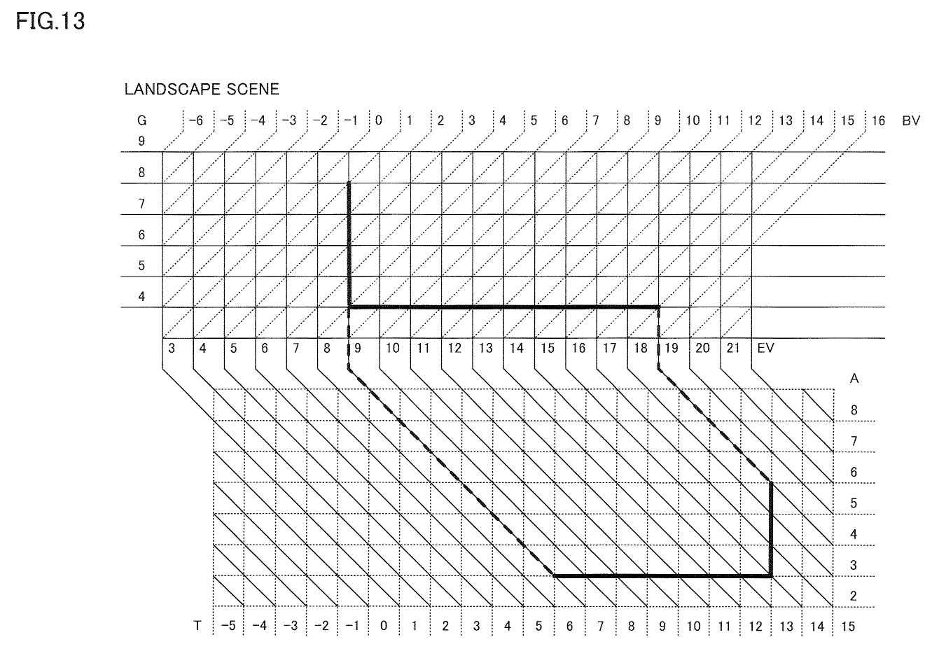

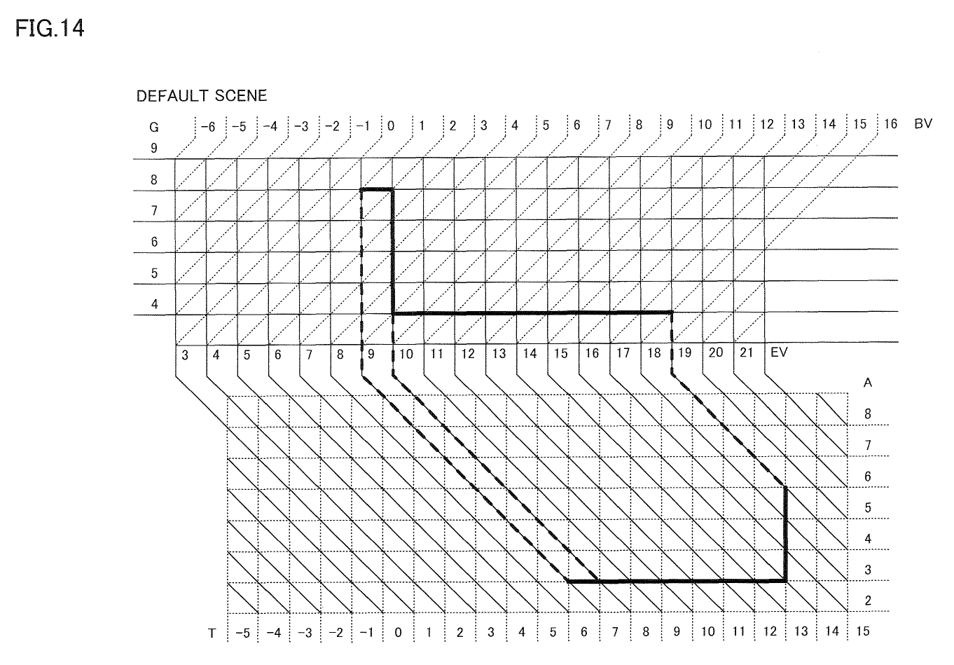

The coordinates (A, T, G) are detected on a bold line drawn on a program chart shown in FIG. 11 when the finalized scene is the night-view scene, and detected on a bold line drawn on a program chart shown in FIG. 12 when the finalized scene is the action scene. Moreover, the coordinates (A, T, G) are detected on a bold line drawn on a program chart shown in FIG. 13 when the finalized scene is the landscape scene, and detected on a bold line drawn on a program chart shown in FIG. 14 when the finalized scene is the default scene.

For example, when the finalized scene is the night-view scene and the calculated appropriate BV value is “3”, (A, T, G)=(3, 7, 7) is detected. Furthermore, when the finalized scene is the action scene and the calculated appropriate BV value is “8”, (A, T, G)=(3, 9, 4) is detected.

To the drivers 18b and 18c and the AGC circuit 20, the aperture amount, the exposure time, and the AGC gain specified by the coordinates (A, T, G) thus detected are set. If a change occurs in the finalized scene, then a program chart adapted to the changed finalized scene is specified and the specified program chart is set as the referring program chart.

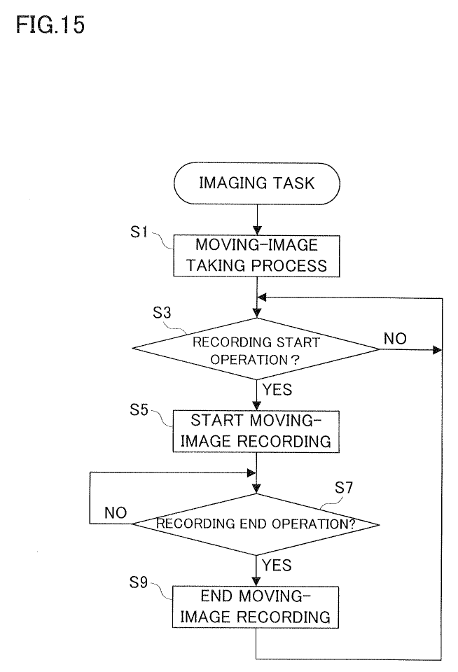

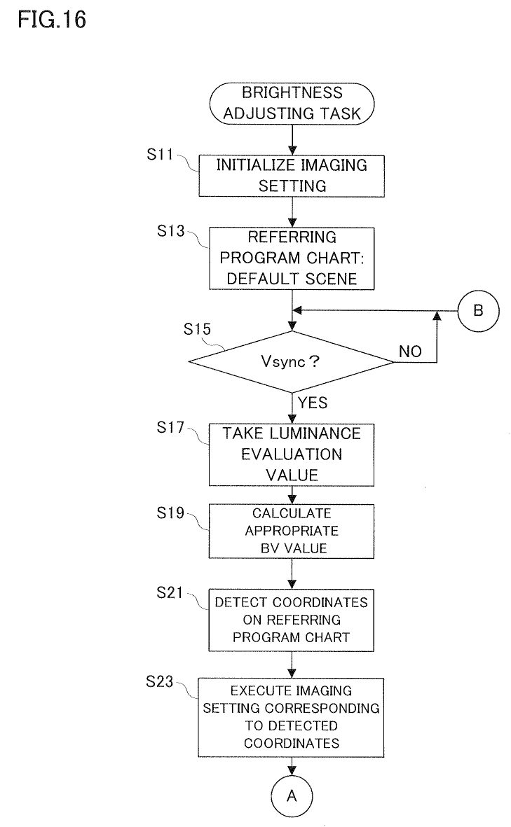

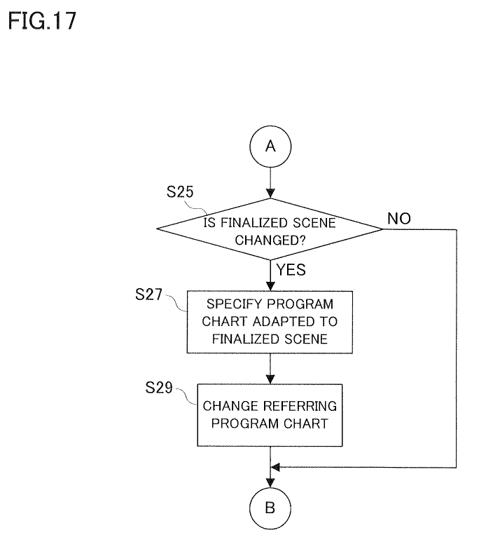

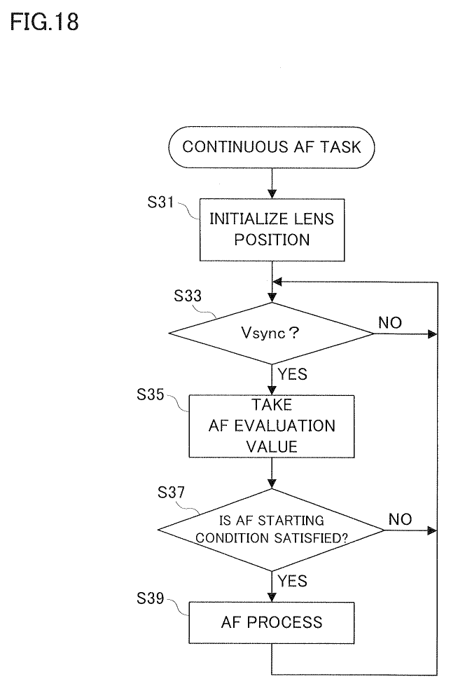

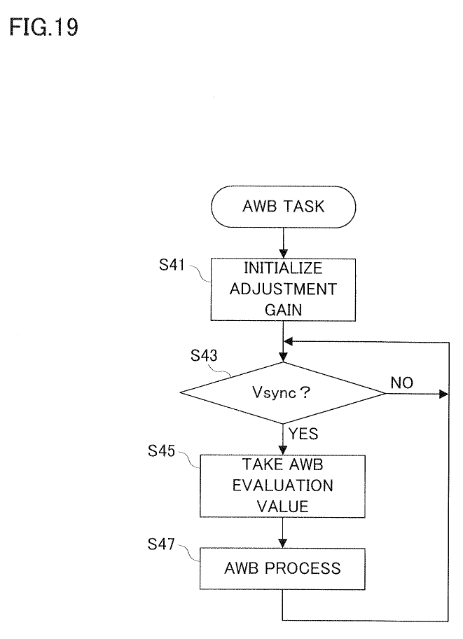

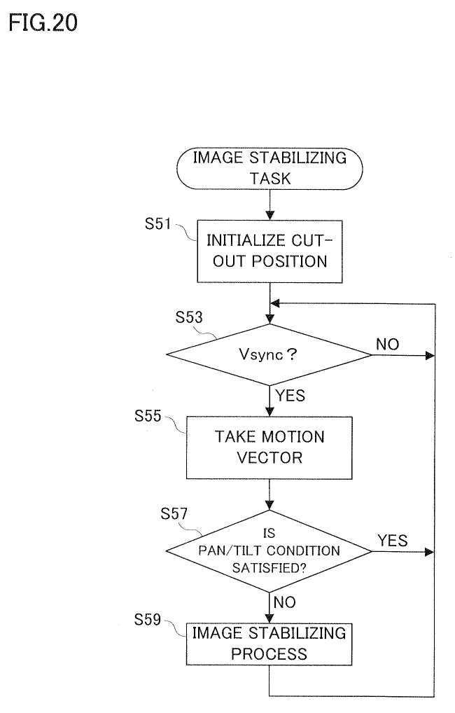

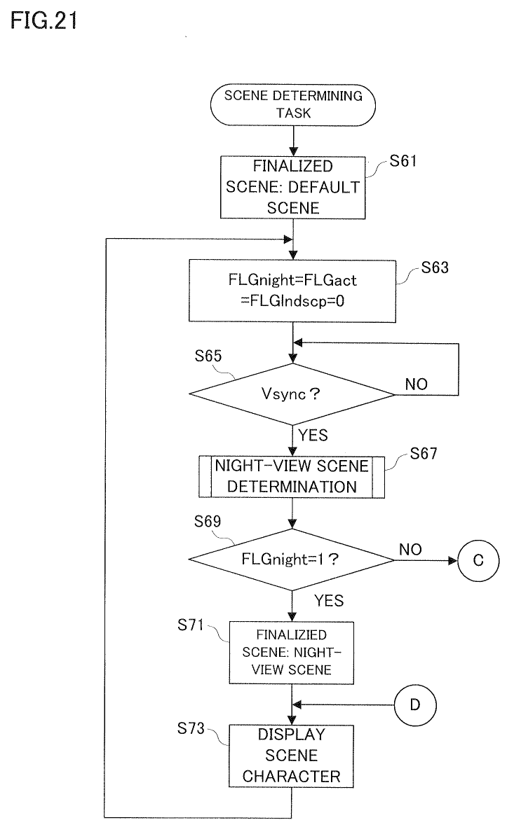

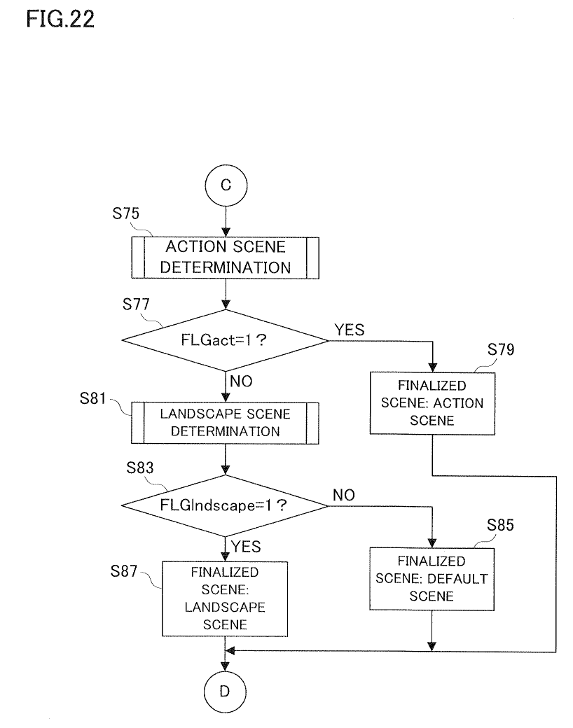

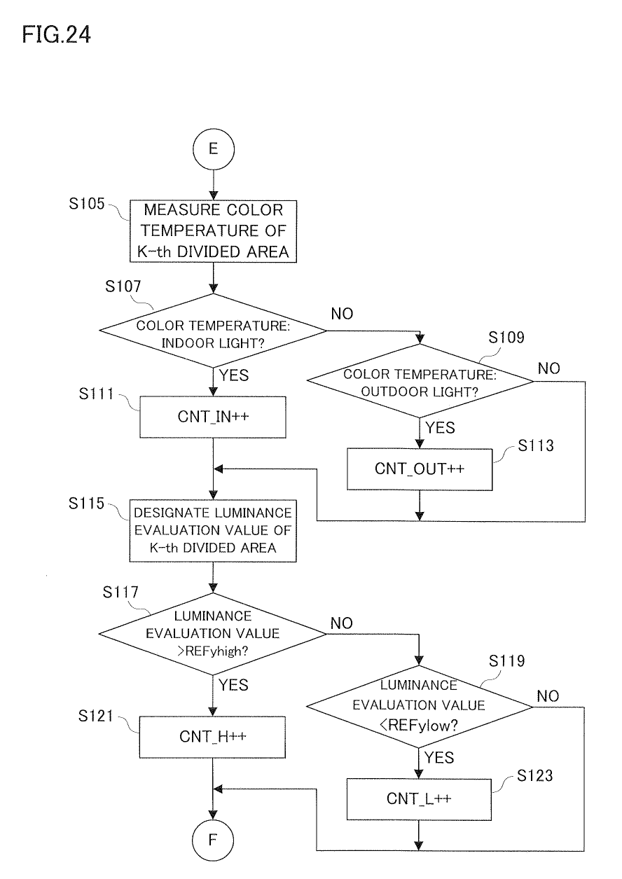

The CPU 48 processes a plurality of tasks including an imaging task shown in FIG. 15, a brightness adjusting task shown in FIG. 16 and FIG. 17, a continuous AF task shown in FIG. 18, an AWB task shown in FIG. 19, an image stabilizing task shown in FIG. 20, and a scene determining task shown in FIG. 21 to FIG. 25, in a parallel manner. It is noted that control programs corresponding to these tasks are stored in a flash memory (not shown).

With reference to FIG. 15, in a step S1, the moving-image taking process is executed. Thereby, the live view image is displayed on the LCD monitor 40. In a step S3, it is repeatedly determined whether or not the recording start operation has been performed. When a determined result is updated from NO to YES, the process advances to a step S5. In the step S5, the recording start command is applied to the I/F 46 in order to start the moving image recording. The OF 46 reads out the image data accommodated in the YUV image area 34b through the memory control circuit 32, and writes the read-out image data into a moving-image file created in the recording medium 46.

In a step S7, it is determined whether or not the recording end operation is performed. When a determined result is updated from NO to YES, the process advances to a step S9 in which the recording end command is applied to the I/F 46 in order to end the moving image recording. The I/F 46 ends reading out the image data, and closes the moving-image file of a recording destination. Upon completion of closing the file, the process returns to the step S3.

With reference to FIG. 16, an imaging setting (=the aperture amount, the exposure time, and the AGC gain) is initialized in a step S11, and in a step S13, a program chart for the default scene is designated as the referring program chart. In a step S15, it is determined whether or not the vertical synchronization signal Vsync is generated and when a determined result is updated from NO to YES, the luminance evaluation values outputted from the luminance evaluating circuit 24 are taken in a step S17.

In a step S19, the appropriate BY value is calculated based on the taken luminance evaluation values, and in a step S21, the coordinates (A, T, G) corresponding to the calculated appropriate BV value are detected on the referring program chart. In a step S23, the aperture amount, the exposure time, and the AGC gain specified by the detected coordinates (A, T, G) are set to the drivers 18b and 18c and the AGC circuit 20.

In a step S25, it is determined whether or not the finalized scene has been changed. When a determined result is NO, the process returns to the step S15 while when the determined result is YES, the process advances to a step S27. In the step S27, the program chart adapted to the changed finalized scene is specified, and in a step S29, the referring program chart is changed to the specified program chart. Upon completion of the changing process, the process returns to the step S15.

With reference to FIG. 18, in a step S31, the position of the focus lens 12 is initialized, and in a step S33, it is determined whether or not the vertical synchronization signal Vsync has been generated. When a determined result is updated from NO to YES, the AF evaluation values outputted from the AF evaluating circuit 26 are taken in a step S35. In a step S37, it is determined whether or not the AF start-up condition is satisfied based on the taken AF evaluation values, and when a determined result is NO, the process returns to the step S33 while when the determined result is YES, the process advances to a step S39. In the step S39, the AF process is executed based on the taken AF evaluation values in order to move the focus lens 12 to a direction in which a focal point is present. Upon completion of the AF process, the process returns to the step S33.

With reference to FIG. 19, in a step S41, the white-balance adjustment gain referred to in the post-processing circuit 36 is initialized, and in a step S43, it is determined whether or not the vertical synchronization signal Vsync has been generated. When a determined result is updated from NO to YES, the AWB evaluation values outputted from the AWB evaluating circuit 28 are taken in a step S45. In a step S47, the AWB process is executed based on the taken AWB evaluation values in order to adjust the white-balance adjustment gain. Upon completion of the AWB process, the process returns to the step S43.

With reference to FIG. 20, in a step S51, the position of the cut-out area CT is initialized. In a step S53, it is determined whether or not the vertical synchronization signal Vsync has been generated. When a determined result is updated from NO to YES, the partial motion vectors outputted from the motion detecting circuit 30 are taken in a step S55. In a step S57, it is determined whether or not the pan/tilt condition described later has been satisfied. When a determined result is NO, the process returns to the step S53 while when the determined result is YES, the process advances to a step S59. In the step S59, the image-stabilizing process is executed by referring to the partial motion vectors taken in the step S55. The cut-out area CT moves to a direction in which the movement of the imaging surface resulting from the camera shake is compensated. Upon completion of the image-stabilizing process, the process returns to the step S53.

With reference to FIG. 21, in a step S61, the default scene is set as the finalized scene, and in a step S63, the flags FLGnight, FLGact and FLGlndscp are set to “0”. In a step S65, it is determined whether or not the vertical synchronization signal Vsync has been generated, and when a determined result is updated from NO to YES, the night-view scene determining process is executed in a step S67. This determining process is executed based on the luminance evaluation value taken under the brightness adjusting task, and when the captured scene is determined to be the night-view scene, the flag FLGnight is updated from “0” to “1”.

In a step S69, whether or not the flag FLGnight indicates “1” is determined, and when a determined result is NO, the process advances to a step S75 while when the determined result is YES, the process advances to a step S71. In the step S71, the night-view scene is used as the finalized scene, and in a step S73, the graphic generator 42 is requested to output a character corresponding to the finalized scene. The character corresponding to the finalized scene is multi-displayed on the live view image. Upon completion of the process in the step S73, the process returns to the step S63.

In the step S75, the action-scene determining process is executed. This determining process is executed based on the partial motion vectors taken under the image stabilizing task and the luminance evaluation values taken under the brightness adjusting task, and when the captured scene is determined to be the action scene, the flag FLGact is updated from “0” to “1”. In a step S77, it is determined whether or not the flag FLGact indicates “1”, and when a determined result is NO, the process advances to a step S81 while when the determined result is YES, the action scene is determined to be the finalized scene in a step S79, and then, the process advances to the step S73.

In the step S81, the landscape scene determining process is executed. This determining process is executed based on the luminance evaluation value taken under the brightness adjusting task, and when the scene is determined to be the landscape scene, the flag FLGlndscp is updated from “0” to “1”. In a step S83, it is determined whether or not the flag FLGlndscp indicates “1”, and when a determined result is NO, the default scene is determined to be the finalized scene in a step S85 while when the determined result is YES, the landscape scene is determined to be the finalized scene in a step S87. Upon completion of the process in the step S85 or S87, the process advances to the step S73.

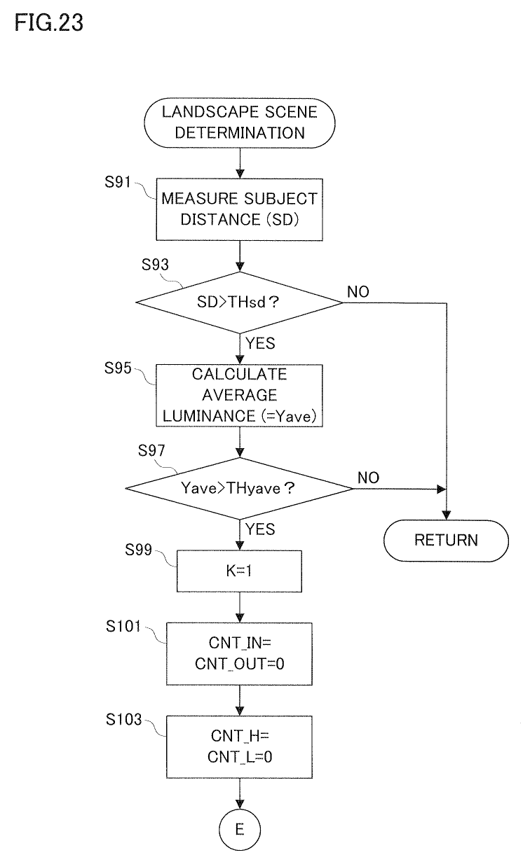

The landscape scene determining process in the step S81 is executed according to a subroutine shown in FIG. 23 to FIG. 25. In a step S91, the subject distance SD is measured with reference to the current position of the focus lens 12. In a step S93, it is determined whether or not the measured subject distance SD exceeds the threshold value THsd. When a determined result is NO, the process returns to the routine in an upper hierarchy while when the determined result in YES, the process advances to a step S95.

In the step S95, the average value of the 256 luminance evaluation values taken under the brightness adjusting task is calculated as “Yave”, and in a step S97, it is determined whether or not the calculated average value Yave exceeds the threshold value THyave. When a determined result is NO, the process returns to the routine in the upper hierarchy while when the determined result is YES, the process advances to a step S99.

In the step S99, a variable K is set to “1”, in a step S101, the variables CNT_IN and CNT_OUT are set to “0”, and in a step S103, the variables CNT_H and CNT_L are set to “0”.

In a step S105, a color temperature of a partial scene image corresponding to the K-th divided area based on the AWB evaluation value taken under the AWB task. In a step S107, it is determined whether or not the measured color temperature is equivalent to the indoor light (Natural White, Daylight or White). In a step S109, it is determined whether or not the measured color temperature is equivalent to the outdoor light (Clear, Cloudy or Shady).

When a determined result of the step S107 is YES, the variable CNT_IN is incremented in a step S111, and thereafter, the process advances to a step S115. When a determined result of the step S109 is YES, the variable CNT_OUT is incremented in a step S113, and thereafter, the process advances to the step S115. When both the determined result of the step S107 and the determined result of the step S109 are NO, the process directly advances to the step S115.

In the step S115, the K-th luminance evaluation value is designated out of the luminance evaluation values taken under the brightness adjusting task. In a step S117, it is determined whether or not the designated luminance evaluation value exceeds the reference value REFyhigh. In a step S119, it is determined whether or not the designated luminance evaluation value falls below the reference value REFylow.

When a determined result of the step S117 is YES, the variable CNT_H is incremented in a step S121, and thereafter, the process advances to a step S125. When a determined result of the step S119 is YES, the variable CNT_L is incremented in a step S123, and thereafter, the process advances to the step S125. When both the determined result of the step S117 and the determined result of the step S119 are NO, the process directly advances to the step S125.

In the step S125, the variable K is incremented, and in a step S127, it is determined whether or not the variable K exceeds “256”. When a determined result is NO, the process returns to the step S105 while when the determined result is YES, the process advances to a step S129.

In the step S129, it is determined whether or not the variable CNT_IN falls below the threshold value THin, and in a step S131, it is determined whether or not the variable CNT_OUT exceeds the threshold value THout. Moreover, in a step S133, it is determined whether or not the variable CNT_H falls below the threshold value THyhigh, and in a step S135, it is determined whether or not the variable CNT_L falls below the threshold value THylow.

When both a determined result of the step S129 and a determined result of the step S131 are YES and when a determined result of the step S133 or a determined result of the step S135 is YES, the flag FLGlndscp is updated to “1” in a step S137, and thereafter, the process returns to the routine in the upper hierarchy.

On the other hand, when the determined result of the step 5129 or the determined result of the step S131 is NO, or when both the determined result of the step S133 and the determined result of the step S135 are NO even when the determined result of the step S129 and the determined result of the step S131 are YES, the process directly returns to the routine in the upper hierarchy.

As is seen from the above description, the imager sensor 16 has the imaging surface capturing the scene and repeatedly outputs the raw image data. The outputted raw image data is amplified by the AGC circuit 20. The exposure amount of the imaging surface and the gain of the AGC circuit 20 are adjusted by the CPU 48 in a manner to match along any one of a plurality of program charts including a specific program chart adapted to the landscape scene (S17 to S29). Here, the CPU 48 determines whether or not the average luminance of the scene image that is based on the raw image data satisfies the first condition (S97). Moreover, the CPU 48 determines whether or not the number of the divided areas having the luminance deviating from the predetermined range (=the range sandwiched between the reference values REFylow and REFyhigh) satisfies the second condition (S115 to S123, S133, S135). Furthermore, the CPU 48 controls, with reference to these determined results, whether or not the referring to the specific program chart should be permitted (S63, S137).

It is noted that the first condition is equivalent to a condition under which the average luminance exceeds the threshold value Yave. Moreover, the second condition is equivalent to a condition under which the number of the luminance evaluation values exceeding the reference value REFyhigh (=CNT_H) falls below the threshold value THyhigh or the number of the luminance evaluation values falling below the reference value REFylow (=CNT_L) falls below the threshold value THylow.

Thus, upon controlling whether or not the referring to the specific program chart suitable for the outdoors should be permitted, not only the average luminance of the scene image but also the number of the divided areas having the luminance deviating from the predetermined range are referred to. This avoids the erroneous determination of whether or not the scene is the outdoors, by extension, the erroneous selection of the adjustment reference, and improves the imaging performance.

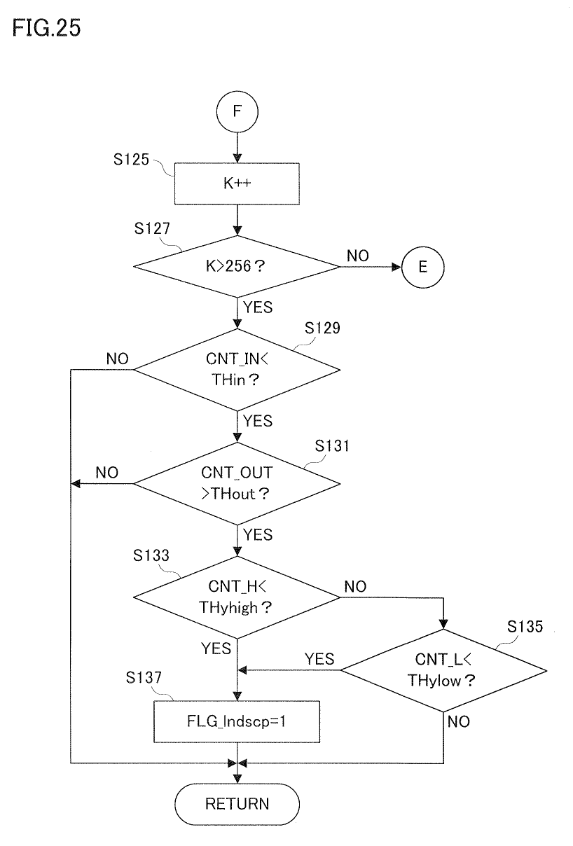

It is noted that the threshold values THylow and THyhigh referred to in the steps S133 and S135 shown in FIG. 25 may be the same values or the different values.

Moreover, in this embodiment, three parameters for adjusting the imaging condition are assumed, i.e., the aperture amount, the exposure time, and the AGC gain; however, in addition thereto, an emphasis degree of an edge and/or a chroma may be assumed. In this case, these degrees of emphasis need to be additionally defined to the program chart.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an image representing a scene captured by an imaging surface;
an adjuster which adjusts an imaging condition by referring to any one of a plurality of adjustment references including a specific adjustment reference suitable for outdoors; and
a controller which controls whether or not the referring by said adjuster to the specific adjustment reference should be permitted, with reference to a determined result of whether or not an average luminance of the image outputted from said imager satisfies a first condition and a determined result of whether or not a ratio of an area having a luminance deviating from a predetermined range occupying in the image outputted from said imager satisfies a second condition.

2. An electronic camera according to claim 1, wherein the second condition includes a condition under which at least one of a ratio of an area exceeding an upper limit of the predetermined range and a ratio of an area falling below a lower limit of the predetermined range falls below a reference.

3. An electronic camera according to claim 1, wherein said controller executes a control process by further referring to a determined result whether or not a color temperature of the image outputted from said imager satisfies a third condition.

4. An electronic camera according to claim 3, wherein the third condition includes a condition under which a ratio of an area having a color temperature equivalent to an outdoor light exceeds a first threshold value and a ratio of an area having a color temperature equivalent to an indoor light falls below a second threshold value.

5. An electronic camera according to claim 1, further comprising:
a focus lens placed in front of said imaging surface; and
an adjuster which continuously adjusts a distance from said focus lens to said imaging surface based on the image outputted from said imager, wherein said controller executes the control process by further referring to a determined result whether or not the distance from said focus lens to said imaging surface satisfies a forth condition.

6. An electronic camera according to claim 1, wherein said controller includes a permitter which permits the referring to the specific adjustment reference on at least a part of the condition that both the first condition and the second condition are satisfied, and a restrictor which restricts the referring to the specific adjustment reference when at least one of the first condition and the second condition is not satisfied.

7. A computer program embodied in a tangible medium, which is executed by a processor of an electronic camera provided with an imager which repeatedly outputs an image representing a scene captured by an imaging surface, comprising:
an adjusting instruction to adjust an imaging condition by referring to any one of a plurality of adjustment references including a specific adjustment reference suitable for outdoors; and
a controlling instruction to control whether or not the referring by said adjusting instruction to the specific adjustment reference should be permitted, with reference to a determined result of whether or not an average luminance of the image outputted from said imager satisfies a first condition and a determined result of whether or not a ratio of an area having a luminance deviating from a predetermined range occupying in the image outputted from said imager satisfies a second condition.

8. An imaging control method executed by an electronic camera provided with an imager which repeatedly outputs an image representing a scene captured by an imaging surface, the imaging control method comprising:
an adjusting step of adjusting an imaging condition by referring to any one of a plurality of adjustment references including a specific adjustment reference suitable for outdoors; and
a controlling step of controlling whether or not the referring by said adjusting step to the specific adjustment reference should be permitted, with reference to a determined result of whether or not an average luminance of the image outputted from said imager satisfies a first condition and a determined result of whether or not a ratio of an area having a luminance deviating from a predetermined range occupying in the image outputted from said imager satisfies a second condition.
